(19) United States
(12) Patent Application Publication
(10) Pub. No.: US 2013/0127639 A1
(43) Pub. Date: May 23, 2013

(54) VIRTUAL TRAFFIC MONITORINGSYSTEM AND A METHOD FOR AVOIDING TRAFFIC RULE VIOLATIONS

(71) Applicants: Elaheh Hassanzadeh Toreh, Tehran (IR); Maryam Mohammadvali, Tehran (IR)

(72) Inventors: Elaheh Hassanzadeh Toreh, Tehran (IR); Maryam Mohammadvali, Tehran (IR)

(73) Assignees: Maryam Mohammadvali, Tehran (IR); Elaheh Hassanzadeh Toreh, Tehran (IR)

(21) Appl. No.: 13/525,261

(22) Filed: Jun. 15, 2012

Related U.S. Application Data
(60) Provisional application No. 61/569,292, filed on Dec. 12, 2011.

(51) Int. Cl. G08G 1/09

(52) U.S. Cl. CPC G08G 1/09
USPC 340/905

(57) ABSTRACT

The embodiments herein disclose a virtual traffic monitoring system and method for avoiding traffic rule violation. The system comprises several slave microcontrollers interfaced with one active device and a sensor. The active device and the sensor in conjunction with several components detect a traffic rule violation. The components include a GPS, a LCD, a Digital Imaging Device, an ADC, a GSM and an ECU. A buzzer is provided in the vehicle for providing an audio alert to the driver of the vehicle. The traffic violation information is sent to the traffic controlling authorities in the form of a text message via an RF transceiver. A power source is provided for supplying an electrical power to the traffic monitoring system components and the sensors.

### CROSS-REFERENCE TO RELATED APPLICATION

This application claims the priority under 35 USC 119(e) of U.S. Provisional Application Ser. No. 61/569,292, filed Dec. 12, 2011, which included by reference herein.

### BACKGROUND

1. Technical Field

The embodiments herein generally relate to a method and a system for traffic management and accident prevention systems. The embodiments herein particularly relate to a method and a system installed in a vehicle for detecting a violation of traffic rules. The embodiments herein more particularly relate to a method and a system for detecting a violation of traffic rules and implementing a necessary action in response to the detected violation of at-least one traffic rule.

2. Description of Related Art

Traffic at any juncture of a street, a road or a highway generally corresponds to a plurality of two or more wheeled vehicle. The traffic has a certain specified set of rules which are needed to be followed by a driver of a vehicle. But in many circumstances, the driver of a vehicle knowingly or unknowingly disobeys the traffic rules which frequently results in a plurality of serious road accidents. The present day traffic authorities implement many innovative systems and methods to reduce or avoid the road accidents. Further a plurality of new systems and methods are implemented by the traffic controlling authorities for identifying the drivers who are involved in the violation of the traffic rules.

Another prior art discloses a system installed at a traffic signal to trace the violation of the traffic rules. The prior art system also sends an alert to the nearby traffic control authorities. The existing prior art comprises a plurality of high end cameras which send the images of real time traffic situation. The concerned traffic authorities receive an alert with details of the vehicle involved in the respective violation of the traffic rule, when there is a violation of a traffic rule.

Another prior art discloses a system and method for detecting the traffic violations like a speed violation and an illegal movement of the vehicle in a prohibited zone. The prior art system implements a navigation mechanism for detecting a geographical location in which the vehicle is travelling. The prior art system further implements a speedometer to detect an instantaneous speed of a vehicle.

However the existing systems and methods lack in providing an alert regarding the traffic violations which take place in the remote are as like national highways. Moreover the existing systems and methods do not interact with a driver of the vehicle which is involved in the violation of the traffic rule. Further the existing systems and methods are restrained to a predetermined fixed set of rule and are not dynamic in nature which results in misleading a driver in circumstances like a change in a terrain structure and a change in a weather condition.

In the view of the foregoing, there is a need for a system and method which detect the violation of various traffic rules. Also there is a need for a system and method to update the set of traffic rule dynamically on the basis of a change in a geographical location, a terrain structure and a weather condition. Further there is a need to provide a system and method for sending an instant alert to the traffic control authorities and to the driver of the vehicle simultaneously.

The above mentioned shortcomings, disadvantages and problems are addressed herein and which will be understood by reading and studying the following specification.

### OBJECTS OF THE EMBODIMENTS

The primary objective of the embodiments herein is to provide a virtual traffic monitoring system and method to detect a traffic rule violation such as a speed violation, an illegal overtaking, a violation of a traffic signal and an illegal movement of a vehicle in a prohibited zone.

Another object of the embodiments herein is to provide a virtual traffic monitoring system and method to disable a vehicle start system when a person attempts to remove the virtual traffic monitoring system from the vehicle.

Yet another object of the embodiments herein is to provide a virtual traffic monitoring system and method to facilitate a communication between the traffic rule monitoring system and the traffic control authorities as well as a driver of the concerned vehicle with a least propagation of delay.

Yet another object of the embodiments herein is to provide a virtual traffic monitoring system and method to provide an audio alert to the driver of the vehicle when the sensors and the components of the virtual traffic monitoring system are malfunctioning.

These and other objects and advantages of the embodiments herein will become readily apparent from the following detailed description taken in conjunction with the accompanying drawings.

### SUMMARY

The various embodiments herein disclose a virtual traffic monitoring system for avoiding or preventing a traffic rule violation. The system comprises a plurality of slave microcontrollers, at-least one active device, a sensor, a Global Position System (GPS),a Liquid Crystal Display (LCD), a Digital Imaging Device, a buzzer, an Analog to Digital Converter (ADC), a Global System for Mobile Communication (GSM) module, an Electronic Control Unit of the vehicle and a power source. The pluralities of slave microcontrollers are interfaced with the at-least one active device and the sensor. The at least one active device is selected from a group consisting of a micro-switch, a Radio Frequency (RF) transceiver, a 2-axis accelerometer, a 3-axis accelerometer, an optical counter, an ultrasonic transceiver-decoder and a compass.

The micro-switch is provided in a seat belt lock of a vehicle to detect a locking of a seat belt in the seat belt lock. The Radio Frequency (RF) transceiver is provided for a communication between a traffic controlling authority and the vehicle. The 2-axis accelerometer is provided for detecting a helical movement of a four wheeler vehicle. The 3-axis accelerometer is provided for detecting a deviation of a two wheeler vehicle from a central axis of movement. The encoder is provided for encoding a signal received from a plurality of sensors and a plurality of the active devices. The decoder is provided for decoding a signal received from the traffic controlling authority. The decoder is connected to the Radio Frequency (RF) transceiver. The optical counter is provided for calculating an instantaneous speed of the vehicle. The ultrasonic transceiver-decoder is provided for sending an alert to a driver of the vehicle. The compass is provided for determining a direction of a movement of the vehicle. The Global Position System (GPS) is provided for determining a plurality of geographical co-ordinates of the vehicle. The Liquid Crystal Display (LCD) is provided in a driver's cabin for displaying a helical movement of the vehicle. The Digital Imaging Device is provided for identifying an illegal overtaking of the vehicle. The buzzer is mounted in the vehicle for providing an audio alert to the driver of the vehicle. The Global System for Mobile Communication (GSM) module is provided for sending a traffic violation information to the traffic controlling authorities. The traffic violation information is sent to the traffic controlling authorities in the form of a text message. The power source is provided for supplying an electrical power to the traffic monitoring system components and the sensors.

According to one embodiment herein, the virtual traffic monitoring system is fused to the Electronic Control Unit to prevent a fake operation. The fake operation includes a disintegration of the virtual traffic monitoring system from the vehicle. The virtual traffic monitoring system sends an audio alert through the buzzer to the driver of the vehicle when at-least one of the sensors malfunctions. The virtual traffic monitoring system restricts a starting of the vehicle when a malfunctioning of at-least one of the sensors and the active devices is detected.

According to one embodiment herein, the plurality of sensors comprises a temperature sensor and a humidity sensor for determining a weather condition, at-least one Infrared (IR) sensor and a light sensor for determining a light intensity.

According to one embodiment herein, the Electronic Control Unit further comprises a primary microcontroller for controlling an initiation of a car start system, a secondary microcontroller for providing an interface between the primary microcontroller and the virtual traffic monitoring system and a driver warning module for providing an alert to the driver regarding the malfunctioning of the pluralities of sensors and components.

According to one embodiment herein, an optical counter further comprises a pulse trigger microcontroller and a shaft encoder. The pulse trigger microcontroller counts the number of pulses entering through a shaft encoder in a specific time interval. The number of pulses counted is used to determine an instantaneous speed of the vehicle.

According to one embodiment herein, the Global Position System (GPS) is connected to a plurality of active devices. The Global Position System (GPS) individually calculates an instantaneous speed of a vehicle in conjunction with at-least one of an accelerometer, the pluralities of sensors, the Radio Frequency (RF) transceiver and the optical counter. An average of the calculated instantaneous speed of the vehicle is compared with a preset speed limit.

According to one embodiment herein, a Radio Frequency (RF) Transceiver sends an alert to a nearby traffic controlling authority in case of a speed limit violation.

According to one embodiment herein, the Infrared (IR) sensor detects an illegal overtaking of the vehicle in conjunction with a Digital Imaging Device and sends an alert to the nearby traffic controlling authority for a respective traffic violation.

According to one embodiment herein, the Infrared (IR) sensor in conjunction with the ultrasonic transceiver-decoder and the Radio Frequency (RF) transceiver manipulates a distance between two moving vehicles and sends an alert to a concerned driver when the distance between two moving vehicles is less than a predetermined safety limit. A predetermined safety limit corresponds to a specified safe distance between two moving vehicles to avoid a collision.

According to one embodiment herein, the Global Position System (GPS) in conjunction with the compass and the Radio Frequency (RF) transceiver detects a symbol in a sign board in a path of a journey of a moving vehicle and sends an alert to a concerned driver corresponding to the detected symbol.

According to one embodiment herein, a symbol in the sign board comprises a U-turn, a No-Parking zone, a Left or Right Turn prohibition.

According to one embodiment herein, the Radio Frequency (RF) transceiver in conjunction with the decoder detects an illegal movement of the vehicle during a stop signal and sends an alert to the nearby traffic controlling authority.

According to one embodiment herein, the compass in conjunction with the Global Positioning System (GPS) detects an illegal reverse movement of the vehicle and sends an alert to the concerned driver.

According to one embodiment herein, a predetermined set of commands is provided to activate the Global System for Mobile Communication (GSM) module. The predetermined set of commands further comprise the commands for sending an SMS, sorting a contact number of a traffic controlling authority and generating a text corresponding to a traffic rule violation.

According to one embodiment herein, the outputs of the pluralities of sensors are provided to the Analog and Digital Converter (ADC) through the Global Positioning System (GPS). The Analog to Digital Converter receives analog inputs from the pluralities of sensors and converts the received analog inputs into a digital data for a long distance communication.

According to one embodiment herein, the alert sent to the traffic controlling authorities is an audio alert as well as a text alert.

According to one embodiment herein, the virtual traffic monitoring system is further connected to the secondary microcontroller of the Electronic Control Unit which is further connected to the primary microcontroller. The primary microcontroller comprises a predefined number of fuse bits. The primary microcontroller is connected to a car start system of the vehicle.

According to one embodiment herein, the driver warning module of the Electronic Control Unit sends an audio alert to the driver of the concerned vehicle in case of violation of a traffic rule. The driver warning module of the Electronic Control Unit provides an audio alert during a malfunctioning of an active device.

The embodiments herein disclose virtual traffic monitoring method to avoid traffic violation. The method comprising the steps of installing a virtual traffic monitoring system in a vehicle, locking a predefined number of fuse bits of a primary microcontroller of a Electronic Control Unit, inspecting a functioning of the installed virtual traffic monitoring system, initiating a vehicle start system based on an inspection of a functioning of the installed virtual traffic monitoring system, tracking a plurality of vehicular motion-affecting factors while driving the vehicle, detecting a plurality of traffic rule violation during a movement of the vehicle based on the pluralities of tracked vehicular motion-affecting factors, determining a continuation of the detected traffic rule violation over a predetermined sampling period and sending an alert to a nearby traffic control authorities for a continued traffic rule violation. The pluralities of vehicular motion-affecting factors comprise a geographical co-ordinates, a weather condition, a light intensity and a terrain structure of a path over the vehicle is moving.

According to one embodiment herein, the plurality of traffic rule violation comprises exceeding a predetermined speed limit of the vehicle, an illegal overtaking of a vehicle, a sudden excessive deviation of a moving vehicle with respect to a preset line of movement of the moving vehicle, driving the vehicle at a distance lesser than a predetermined safe distance between the two moving vehicles, parking the vehicle in a no-parking zone, unfastening a seatbelt by the driver while driving the vehicle, an illegal movement of the vehicle in a reverse direction and an illegal movement of the vehicle in a left turn or a right turn or in a prohibited zone. A predetermined safe distance corresponds to a specified safe distance between two moving vehicles to avoid a collision.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The other objects, features and advantages will occur to those skilled in the art from the following description of the preferred embodiment and the accompanying drawings in which:

FIG. 1 illustrates a block diagram of a virtual traffic monitoring system for avoiding a traffic rule violation, according to an embodiment herein.

FIG. 2 illustrates a flowchart for a process in a virtual traffic monitoring method for avoiding a traffic rule violation, according to an embodiment herein.

FIG. 3 illustrates a functional block diagram of a humidity sensor in the virtual traffic monitoring system for avoiding a traffic rule violation, according to an embodiment herein.

FIG. 4 illustrates a block circuit diagram of a humidity sensor in the virtual traffic monitoring system for avoiding a traffic rule violation, according to an embodiment herein.

FIG. 5 illustrates a block diagram of a temperature sensor in the virtual traffic monitoring system for avoiding a traffic rule violation, according to an embodiment herein.

FIG. 6 illustrates a block diagram of a light sensor in the virtual traffic monitoring system for avoiding a traffic rule violation, according to an embodiment herein.

FIG. 7 illustrates a flow chart for a method of detecting an illegal overtaking by a moving vehicle using the virtual traffic monitoring system, according to an embodiment herein.

FIG. 8 illustrates a flowchart for a method of detecting an illegal crossing of a traffic signal by a moving vehicle using the virtual traffic monitoring system, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein disclose a virtual traffic monitoring system for avoiding or preventing a traffic rule violation. The system comprises a plurality of slave microcontrollers, at-least one active device, a sensor, a Global Position System (GPS),a Liquid Crystal Display (LCD), a Digital Imaging Device, a buzzer, an Analog to Digital Converter (ADC), a Global System for Mobile Communication (GSM) module, an Electronic Control Unit of the vehicle and a power source. The pluralities of slave microcontrollers are interfaced with the at-least one active device and the sensor. The at least one active device is selected from a group consisting of a micro-switch, a Radio Frequency (RF) transceiver, a 2-axis accelerometer, a 3-axis accelerometer, an optical counter, an ultrasonic transceiver-decoder and a compass.

The micro-switch is provided in a seat belt lock of a vehicle to detect a locking of a seat belt in the seat belt lock. The Radio Frequency (RF) transceiver is provided for a communication between a traffic controlling authority and the vehicle. The 2-axis accelerometer is provided for detecting a helical movement of a four wheeler vehicle. The 3-axis accelerometer is provided for detecting a deviation of a two wheeler vehicle from a central axis of movement. The encoder is provided for encoding a signal received from a plurality of sensors and a plurality of the active devices. The decoder is provided for decoding a signal received from the traffic controlling authority. The decoder is connected to the Radio Frequency (RF) transceiver. The optical counter is provided for calculating an instantaneous speed of the vehicle. The ultrasonic transceiver-decoder is provided for sending an alert to a driver of the vehicle. The compass is provided for determining a direction of a movement of the vehicle. The Global Position System (GPS) is provided for determining a plurality of geographical co-ordinates of the vehicle. The Liquid Crystal Display (LCD) is provided in a driver's cabin for displaying a helical movement of the vehicle. The Digital Imaging Device is provided for identifying an illegal overtaking of the vehicle. The buzzer is mounted in the vehicle for providing an audio alert to the driver of the vehicle. The Global System for Mobile Communication (GSM) module is provided for sending a traffic violation information to the traffic controlling authorities. The traffic violation information is sent to the traffic controlling authorities in the form of a text message. The power source is provided for supplying an electrical power to the traffic monitoring system components and the sensors.

According to one embodiment herein, the virtual traffic monitoring system is fused to the Electronic Control Unit to prevent a fake operation. The fake operation includes a disintegration of the virtual traffic monitoring system from the vehicle. The virtual traffic monitoring system sends an audio alert through the buzzer to the driver of the vehicle when at-least one of the sensors malfunctions. The virtual traffic monitoring system restricts a starting of the vehicle when a malfunctioning of at-least one of the sensors and the active devices is detected.

According to one embodiment herein, the plurality of sensors comprises a temperature sensor and a humidity sensor for determining a weather condition, at-least one Infrared (IR) sensor and a light sensor for determining a light intensity.

According to one embodiment herein, the Electronic Control Unit further comprises a primary microcontroller for controlling an initiation of a car start system, a secondary microcontroller for providing an interface between the primary microcontroller and the virtual traffic monitoring system and a driver warning module for providing an alert to the driver regarding the malfunctioning of the pluralities of sensors and components.

According to one embodiment herein, an optical counter further comprises a pulse trigger microcontroller and a shaft encoder. The pulse trigger microcontroller counts the number of pulses entering through a shaft encoder in a specific time interval. The number of pulses counted is used to determine an instantaneous speed of the vehicle.

According to one embodiment herein, the Global Position System (GPS) is connected to a plurality of active devices. The Global Position System (GPS) individually calculates an instantaneous speed of a vehicle in conjunction with at-least one of an accelerometer, the pluralities of sensors, the Radio Frequency (RF) transceiver and the optical counter. An average of the calculated instantaneous speed of the vehicle is compared with a preset speed limit.

According to one embodiment herein, a Radio Frequency (RF) Transceiver sends an alert to a nearby traffic controlling authority in case of a speed limit violation.

According to one embodiment herein, the Infrared (IR) sensor detects an illegal overtaking of the vehicle in conjunction with a Digital Imaging Device and sends an alert to the nearby traffic controlling authority for a respective traffic violation.

According to one embodiment herein, the Infrared (IR) sensor in conjunction with the ultrasonic transceiver-decoder and the Radio Frequency (RF) transceiver manipulates a distance between two moving vehicles and sends an alert to a concerned driver when the distance between two moving vehicles is less than a predetermined safety limit. A predetermined safety limit corresponds to a specified safe distance between two moving vehicles to avoid a collision.

According to one embodiment herein, the Global Position System (GPS) in conjunction with the compass and the Radio Frequency (RF) transceiver detects a symbol in a sign board in a path of a journey of a moving vehicle and sends an alert to a concerned driver corresponding to the detected symbol.

According to one embodiment herein, a symbol in the sign board comprises a U-turn, a No-Parking zone, a Left or Right Turn prohibition.

According to one embodiment herein, the Radio Frequency (RF) transceiver in conjunction with the decoder detects an illegal movement of the vehicle during a stop signal and sends an alert to the nearby traffic controlling authority.

According to one embodiment herein, the compass in conjunction with the Global Positioning System (GPS) detects an illegal reverse movement of the vehicle and sends an alert to the concerned driver.

According to one embodiment herein, a predetermined set of commands is provided to activate the Global System for Mobile Communication (GSM) module. The predetermined set of commands further comprise the commands for sending an SMS, sorting a contact number of a traffic controlling authority and generating a text corresponding to a traffic rule violation.

According to one embodiment herein, the outputs of the pluralities of sensors are provided to the Analog and Digital Converter (ADC) through the Global Positioning System (GPS). The Analog to Digital Converter receives analog inputs from the pluralities of sensors and converts the received analog inputs into a digital data for a long distance communication.

According to one embodiment herein, the alert sent to the traffic controlling authorities is an audio alert as well as a text alert.

According to one embodiment herein, the virtual traffic monitoring system is further connected to the secondary microcontroller of the Electronic Control Unit which is further connected to the primary microcontroller. The primary microcontroller comprises a predefined number of fuse bits. The primary microcontroller is connected to a car start system of the vehicle.

According to one embodiment herein, the driver warning module of the Electronic Control Unit sends an audio alert to the driver of the concerned vehicle in case of violation of a traffic rule. The driver warning module of the Electronic Control Unit provides an audio alert during a malfunctioning of an active device.

The embodiments herein disclose virtual traffic monitoring method to avoid traffic violation. The method comprising the steps of installing a virtual traffic monitoring system in a vehicle, locking a predefined number of fuse bits of a primary microcontroller of a Electronic Control Unit, inspecting a functioning of the installed virtual traffic monitoring system, initiating a vehicle start system based on an inspection of a functioning of the installed virtual traffic monitoring system, tracking a plurality of vehicular motion-affecting factors while driving the vehicle, detecting a plurality of traffic rule violation during a movement of the vehicle based on the pluralities of tracked vehicular motion-affecting factors, determining a continuation of the detected traffic rule violation over a predetermined sampling period and sending an alert to a nearby traffic control authorities for a continued traffic rule violation. The pluralities of vehicular motion-affecting factors comprise a geographical co-ordinates, a weather condition, a light intensity and a terrain structure of a path over the vehicle is moving.

According to one embodiment herein, the plurality of traffic rule violation comprises exceeding a predetermined speed limit of the vehicle, an illegal overtaking of a vehicle, a sudden excessive deviation of a moving vehicle with respect to a preset line of movement of the moving vehicle, driving the vehicle at a distance lesser than a predetermined safe distance between the two moving vehicles, parking the vehicle in a no-parking zone, unfastening a seatbelt by the driver while driving the vehicle, an illegal movement of the vehicle in a reverse direction and an illegal movement of the vehicle in a left turn or a right turn or in a prohibited zone. A predetermined safe distance corresponds to a specified safe distance between two moving vehicles to avoid a collision.

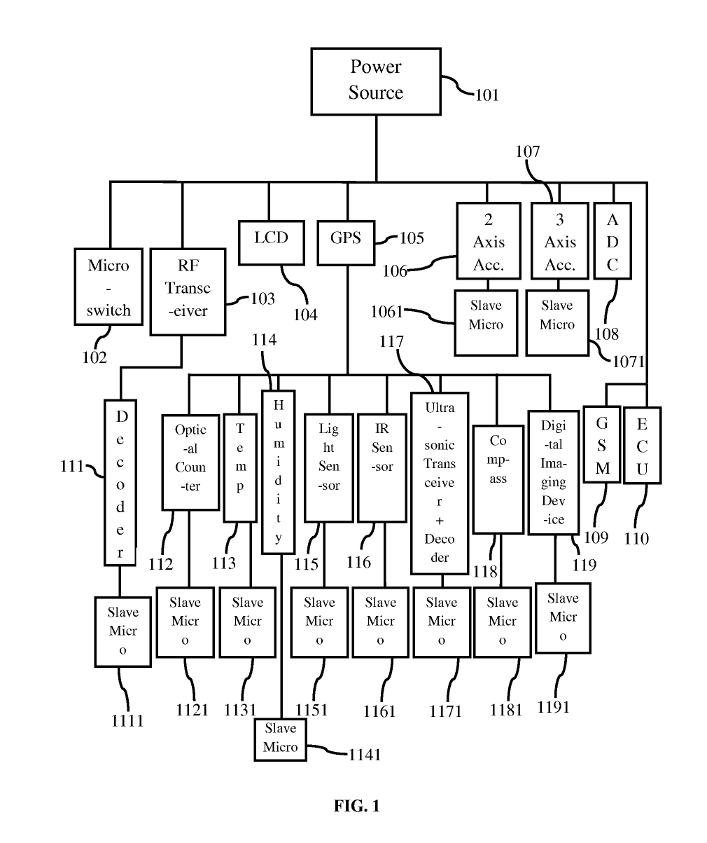

FIG. 1 illustrates a block diagram for a virtual traffic monitoring system for avoiding a traffic rule violation, according to an embodiment herein. With respect to FIG. 1, the virtual traffic monitoring system comprises a plurality of slave microcontrollers 1061,1071 1111,1121,1131,1141,1151,1161,1171,1181,1191, at-least one active device, a plurality of sensors 113-116, a Global Position System (GPS) 105, a Liquid Crystal Display (LCD) 104, a Digital Imaging Device 119, a buzzer, an Analog to Digital Converter (ADC) 108, a Global System for Mobile Communication (GSM) module 109, an Electronic Control Unit of the vehicle 110 and a power source 101. The pluralities of slave microcontrollers 1061,1071 1111,1121,1131,1141,1151,1161,1171,1181,1191 are interfaced with the at-least one active device and the sensor 113-116. The at least one active device is selected from a group consisting of a micro-switch 102, a Radio Frequency (RF) transceiver 103, a 2-axis accelerometer 106, a 3-axis accelerometer 107, an optical counter 112, an ultrasonic transceiver-decoder 117 and a compass 118. The micro-switch 102 is provided in a seat belt lock of a vehicle to detect a locking of a seat belt in the seat belt lock. The Radio Frequency (RF) 103 transceiver is provided for communicating between a traffic controlling authority and the vehicle. The 2-axis accelerometer 106 is provided for detecting a helical movement of a four wheeler vehicle. The 3-axis accelerometer 107 is provided for detecting a deviation of a two wheeler vehicle from a central axis of movement. An encoder is provided for encoding a signal received from a plurality of sensors 113-116 and a plurality of the active devices. A decoder 111 is provided for decoding a signal received from the traffic controlling authority. The decoder 111 is connected to the Radio Frequency (RF) transceiver 103. The optical counter 112 is provided for calculating an instantaneous speed of the vehicle. The ultrasonic transceiver-decoder 117 is provided for sending an alert to a driver of the vehicle. The compass 118 is provided for determining a direction of a movement of the vehicle. The Global Position System (GPS) 105 is provided for determining a plurality of geographical co-ordinates of the vehicle. The Liquid Crystal Display (LCD) 104 is provided in a driver's cabin for displaying the helical movement of the vehicle. The Digital Imaging Device 119 is provided for identifying an illegal overtaking of the vehicle. The buzzer is incorporated in the vehicle for providing an audio alert to the driver of the vehicle. The Global System for Mobile Communication (GSM) module 109 is provided for sending traffic violation information to the traffic controlling authorities. The traffic violation information is sent to the traffic controlling authorities in the form of a text message. The power source 101 is provided for supplying an electrical power to the traffic monitoring system components and the sensors.

The virtual traffic monitoring system is fused to the Electronic Control Unit 110 to eliminate a fake operation. The fake operation includes a disintegration of the virtual traffic monitoring system from the vehicle. The Electronic Control Unit 110 comprises a primary microcontroller for controlling an initiation of a car start system. Also a secondary microcontroller is incorporated in the Electronic Control Unit for providing an interface between the primary microcontroller and the virtual traffic monitoring system. Further the Electronic Control Unit 110 comprises a driver warning module for providing an alert to the driver regarding the malfunctioning of the pluralities of sensors 113-116 and components.

The plurality of sensors comprises a temperature sensor 113 and a humidity sensor 114 for determining a weather condition, at-least one Infrared (IR) sensor 116 and a light sensor 115 for determining a light intensity.

An optical counter 112 further comprises a pulse trigger microcontroller and a shaft encoder. The pulse trigger microcontroller counts the number of pulses entering through a shaft encoder in a specific time interval. The number of counted pulse is used to determine an instantaneous speed of the vehicle.

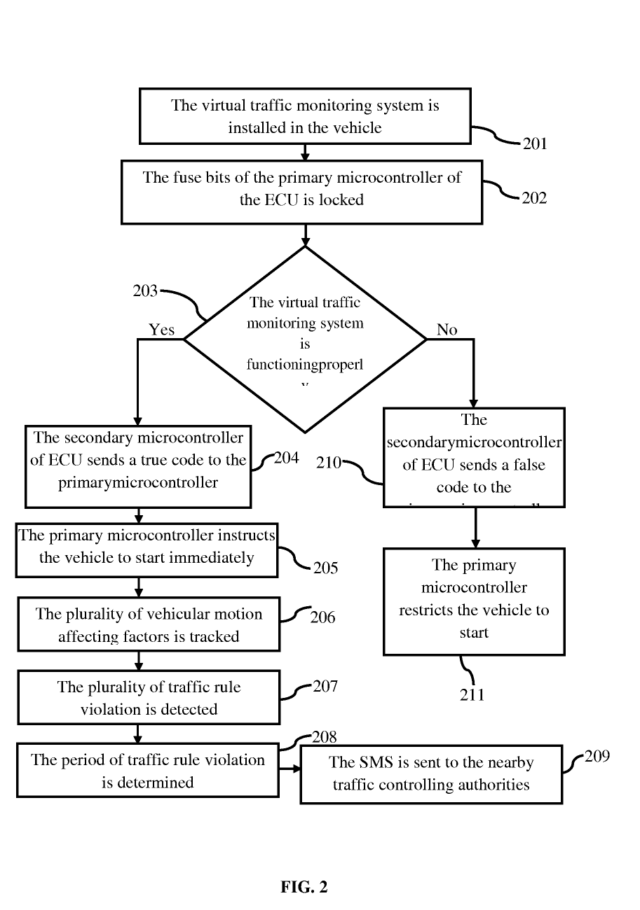

FIG. 2 illustrates a flowchart for a process in a virtual traffic monitoring method for avoiding a traffic rule violation, according to an embodiment herein. With respect to FIG. 2, the virtual traffic monitoring system is installed in a vehicle (201). The fuse bits of the primary microcontroller are locked after installing the virtual traffic monitoring system (202). The virtual traffic monitoring system checks the functioning of the active devices and the pluralities of sensors (203).When the active devices and the plurality of sensors function properly, then the second microprocessor of the Electronic Control Unit sends a true code to the first microprocessor (204). The first microprocessor instructs the vehicle to start immediately after receiving the true code (205). The plurality of vehicular motion affecting factors is continuously tracked (206). The plurality of vehicular motion affecting factors further comprises a weather condition, a light intensity in the surroundings of the vehicle, a road or highway terrain structure and a geographical location. The virtual traffic monitoring system detects the plurality of traffic rule violation (207). The virtual traffic monitoring system also tracks the period of a traffic rule violation (208). When the period of a traffic rule violation is extended, then the virtual traffic monitoring system sends an SMS alert to the nearby traffic controlling authorities (209).

The plurality of traffic rule violation comprises exceeding a predetermined speed limit of the vehicle and an illegal overtaking of a vehicle. The plurality of traffic rule violation also comprises a sudden excessive deviation of a moving vehicle with respect to the present line of movement of the moving vehicle and driving the vehicle at a distance lesser than a predetermined safe distance between the two moving vehicles. The plurality of traffic rule violation further comprises parking the vehicle in a no-parking zone, unfastening a seatbelt by the driver while driving the vehicle, an illegal movement of the vehicle in a reverse direction and an illegal movement of the vehicle in a left turn or right turn or in a prohibited zone. A predetermined safe distance corresponds to a specified safe distance between the two moving vehicles to avoid a collision.

When the active devices and the plurality of sensors do not function properly, then the second microprocessor of the Electronic Control Unit sends a false code to the first microprocessor (210). The first microprocessor restricts the vehicle to start, after receiving the false code (211).

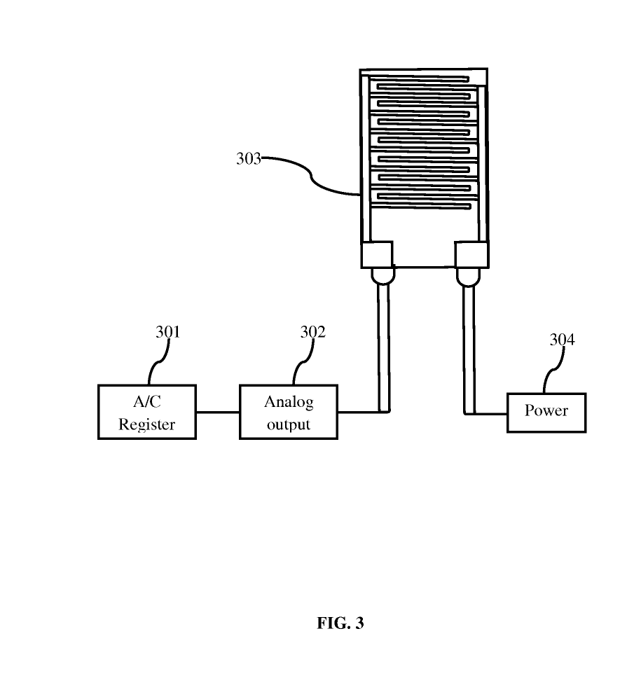

FIG. 3 illustrates a functional block diagram of a humidity sensor in the virtual traffic monitoring system for avoiding a traffic rule violation, according to an embodiment herein. With respect to FIG. 3, the humidity sensor 303 consists of two pins. A first pin of the humidity sensor 303 is connected to the power source 304. A second pin of the humidity sensor 303 is connected to A/C register 301 of the slave microcontroller via an analog output 302. The humidity sensor 303 continuously senses the moisture content in the air and produces the analog results which is stored and updated in the A/C register 301 via the output 302.

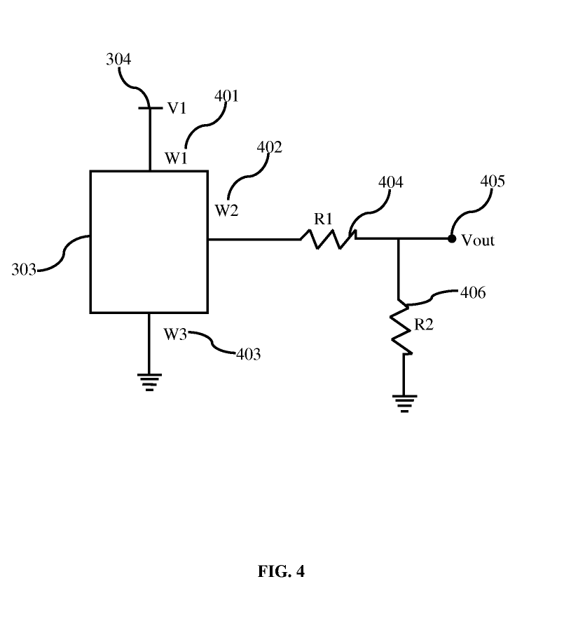

FIG. 4 illustrates a block circuit diagram for a humidity sensor in the virtual traffic monitoring system for avoiding a traffic rule violation, according to an embodiment herein. With respect to FIG. 4, the humidity sensor 303 comprises three pins which are designated herein as a primary pin (W1) 401, a secondary pin (W2) 402 and a tertiary pin (W3) 403. The primary pin (W1) 401 is connected to the power source 304 with a supply voltage (V1). The secondary pin (W2) 402 is connected to a resistor (R1) 404. The resistor (R1) 404 is further connected to an output node 405 and a resistor (R2) 406. The output node 405 and a resistor (R2) 406 are connected in parallel to each other. The voltage (Vout) at the output node 405 and the voltage appears across the resistor (R2) 406 are same. The output node 405 is further connected to the A/C register of a slave microcontroller. The A/C register stores and updates the analog result provided through the output voltage node (Vout) 405. The resistor (R1) 404 controls the output voltage (Vout) 405. The tertiary pin (W3) 403 is connected to a ground or a neutral base and is optional in nature.

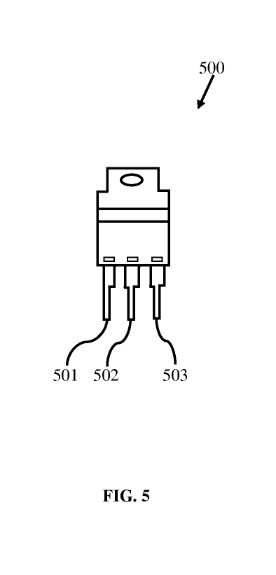

FIG. 5 illustrates a schematic block diagram of a temperature sensor in the virtual traffic monitoring system for avoiding a traffic rule violation, according to an embodiment herein. With respect to FIG. 5, the temperature sensor 500 comprises three pins which are designated herein as a first pin 501, a second pin 502 and a third pin 503. The first pin 501 is connected to the power source, the second pin 502 is connected to a ground or a neutral base and the third pin 503 is connected to an output node. The output node is further connected to an A/C register of a slave microcontroller. The A/C register stores and updates the analog result provided through the voltage node. The analog result is in the form of the A/C voltage which corresponds to an instantaneous temperature sensed through the temperature sensor 500. The temperature sensor 500 is generally a transistor with three nodes an emitter, a base and a collector. The transistor further comprise two diode junctions named as an emitter-base junction and a collector-base junction. A variation in a temperature results in an increase or a decrease in a voltage drop across the emitter-base junction at a constant rate. The increase or decrease in the voltage drop results in a variation in a current flowing across the collector-base junction. The variation in the current across the collector-base junction forms a varying analog signal which is fed into the A/C register.

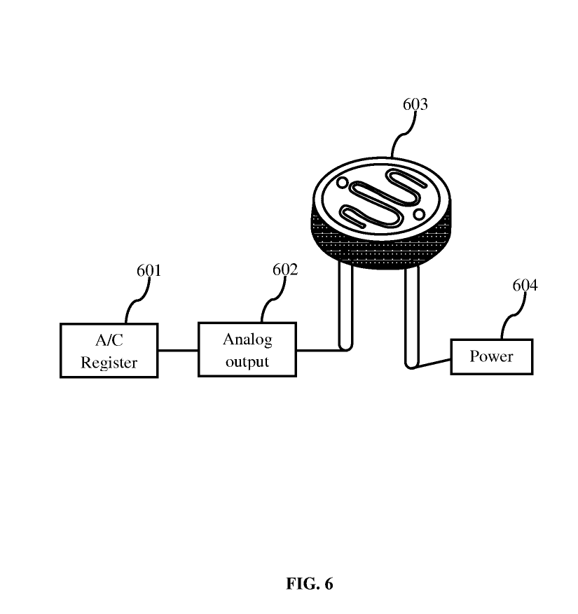

FIG. 6 illustrates a block diagram of a light sensor in the virtual traffic monitoring system for avoiding a traffic rule violation, according to an embodiment herein. With respect to FIG. 6, the light sensor 603 comprises two pins which are designated herein as a primary pin and a secondary pin. The primary pin is connected with a power source 604. The secondary pin is connected to an analog output 602. The analog output 602 is further connected to an A/C register 601 of a slave microcontroller 1151. The A/C register 601 stores and updates the analog result provided through the A/C output 602. The analog result is in the form of an A/C voltage which corresponds to a varying light intensity sensed through the light sensor 603. The light sensor 603 is generally a diode working in a reverse bias. The variation in a light intensity falling on the diode generates new electron-hole pairs near a junction of the diode. The newly formulated electron-pair gains sufficient thermal energy to cross a junction barrier. The junction barrier is a specific voltage at which a diode starts conducting. The newly formulated electron-hole pair flows through a wire connected to the opposite terminals of the diode. The wire is further connected to a load. The load can be of resistive or inductive or capacitive in nature. The flow of electrons and holes constitutes a current which generate varying analog voltage across the load. The generated analog voltage is fed into the A/C register 601.

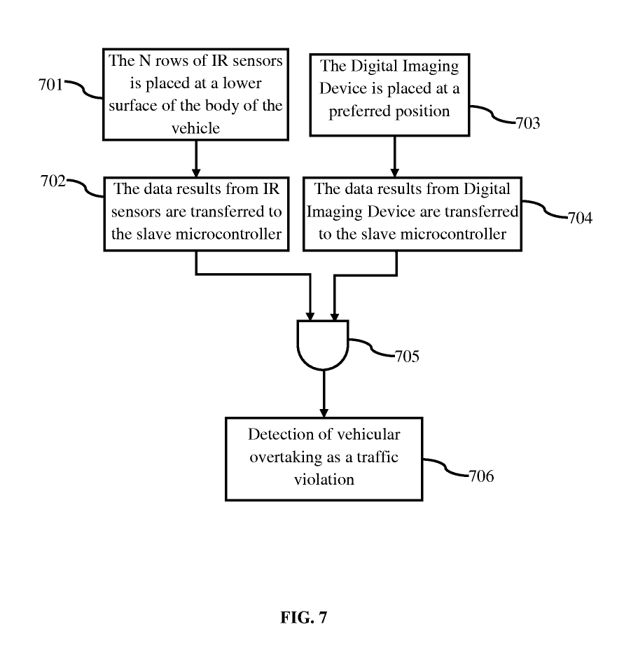

FIG. 7 illustrates a flow chart for a method of detecting an illegal overtaking by a moving vehicle using the virtual traffic monitoring system, according to an embodiment herein. With respect to FIG. 7, a predefined number of rows of infrared sensors are placed at a lower surface of the body in the vehicle (701). The predefined number of rows of infrared sensors scans the ground. The data results of the scanned ground is provided to a slave microcontroller (702). A digital imaging device is also installed at a preferred position for scanning the ground (703). The data results of the scanned ground acquired from the digital imaging device is provided to a slave microcontroller (704). The slave microcontroller corresponding to the predefined number of rows of infrared sensors and the digital imaging device comprises a pre-defined “cut-line”. The predefined “cut-line” is a minimum safe distance for avoiding a collision between two moving vehicles. An overtaking by a moving vehicle is marked as an illegal overtaking when the respective vehicle crosses the pre-defined “cut-line”. When the moving vehicle does an illegal overtaking, the output of the slave microcontroller comes out as “1” otherwise the output comes out to be “0”. Thus, the predefined number of rows of infrared sensors and the digital imaging device provides the individual results for a moving vehicle through their respective slave microcontrollers. The results provided through the predefined number of rows of infrared sensors and the digital imaging device are fed to an “AND” gate (705). The overtaking of vehicle is finally marked as illegal when the output of the “AND” gate comes out as “1” (706). The output of the “AND” gate is “1” only when both the output provided by the slave microcontrollers are “1”. The Radio Frequency (RF) transceiver sends an alert to the nearby traffic controlling authorities for the illegal overtaking of the vehicle.

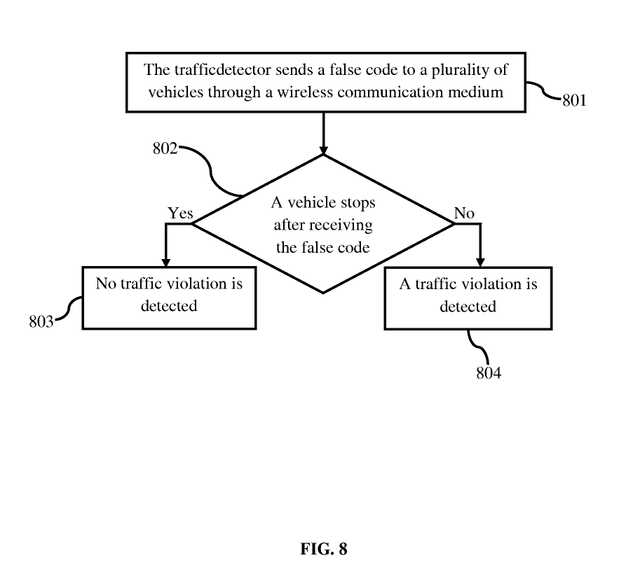

FIG. 8 illustrates a flowchart for a method of detecting an illegal crossing of a traffic signal by a moving vehicle using the virtual traffic monitoring system, according to an embodiment herein. With respect to FIG. 8, the traffic signal is fitted with a traffic detector. The traffic detector sends a false code to the moving vehicles when a traffic signal light is “red” which is a command for the vehicles to stop (801). It is detected whether the vehicle stops after receiving a false code (802). If the vehicle stops after receiving the false code from the traffic detector, then no violation of the traffic signal crossing is detected (803). If the vehicle does not stop after receiving the false code from the traffic detector, then a violation of the traffic signal crossing is detected (804). The Radio Frequency (RF) transceiver sends an alert to the nearby traffic controlling authorities for the respective violation.

According to one embodiment herein, the 2-axis accelerometer detects a helical movement along X and Y axis along with an acceleration of the four wheeled vehicles. An output pin of the 2-axis accelerometer has an analog voltage output which is connected to an A/C register of a slave microcontroller.

According to one embodiment herein, the 3- axis accelerometer detects the helical movement along X, Y and Z axis along with an acceleration of the four wheeled vehicles. An output pin of the 3-axis accelerometer has an analog voltage output which is connected to an A/C register of a slave microcontroller.

The virtual traffic monitoring system of the embodiments herein is installed in the vehicle. A traffic violation is detected near the traffic signal junctions as well as in the areas where no traffic surveillance is present. The virtual traffic monitoring system of the embodiments herein detects a violation of speed limit based on the comparison of an averaged speed result produced by a combination of the GPS, the optical counter and the accelerometer. Thus an efficient detection is made by comparing and reverifying the averaged speed and the predetermined speed limit.

The virtual traffic monitoring system of the embodiments herein implements a plurality of sensors which provide their individual data for a terrain structure over which a vehicle is travelling and a weather condition of the geographical location in which the vehicle is travelling. Based on the data provided by the pluralities of the sensors, the Electronic Control Unit of the vehicle updates the instantaneous speed limit. Thus virtual traffic monitoring system of the embodiments herein removes an ambiguity regarding a speed limit for a geographical area and a weather condition.

The virtual traffic monitoring system of the embodiments herein is fused to the Electronic Control Unit of the vehicle to eliminate a fake action which occurs due to the removal of the virtual traffic monitoring system for the vehicle. The virtual traffic monitoring system of the embodiments here in judges an illegal overtaking of the moving vehicle by comparing the results produce by the Infrared (IR)sensors and the digital imaging device. Thus an efficient decision is made by comparing and re-verifying the individual results produced by the Infrared (IR) sensors and the digital imaging device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A virtual traffic monitoring system for avoiding a traffic rule violation, the system comprises:
a plurality of slave microcontrollers, wherein the plurality of slave microcontrollers are interfaced with at-least one active device and a sensor, wherein the at least one active device is selected from a group consisting of a micro-switch, a Radio Frequency (RF) transceiver, a 2-axis accelerometer, a 3-axis accelerometer, an optical counter, an ultrasonic transceiver-decoder and a compass, wherein the micro-switch is provided in a seat belt lock of a vehicle to detect a locking of a seat belt in the seat belt lock, wherein the Radio Frequency (RF) transceiver is provided for communicating between a traffic controlling authority and the vehicle, wherein the 2-axis accelerometer is provided for detecting a helical movement of a four wheeler vehicle, wherein the 3-axis accelerometer is provided for detecting a deviation of a two wheeler vehicle from a central axis of movement, wherein the encoder is provided for encoding a signal from a plurality of sensors and a plurality of the active devices, wherein the decoder is provided for decoding a signal received from the traffic controlling authority and wherein the decoder is connected to the Radio Frequency (RF) transceiver, wherein the optical counter is provided for calculating an instantaneous speed of the vehicle, wherein the ultrasonic transceiver-decoder is provided for sending an alert to a driver of the vehicle, wherein the compass is provided for determining a direction of a movement of the vehicle;
a Global Position System (GPS) for determining a plurality of geographical co-ordinates of the vehicle;
a Liquid Crystal Display (LCD) provided in a driver's cabin for displaying the helical movement of the vehicle;
a Digital Imaging Device for identifying an illegal overtaking of the vehicle;
a buzzer for providing an audio alert to the driver of the vehicle;
an Analog to Digital Converter (ADC);
a Global System for Mobile Communication (GSM) module for sending a traffic violation information to the traffic controlling authorities, and wherein the traffic violation information is sent in the form of a text message;
an Electronic Control Unit of the vehicle; and
a power source for supplying an electrical power to the traffic monitoring system components and the sensors, wherein the virtual traffic monitoring system is fused to the Electronic Control Unit to eradicate a fraud, wherein the fraud is done by a disintegration of the virtual traffic monitoring system, wherein the virtual traffic monitoring system sends an audio alert through the buzzer to the driver of the vehicle when at-least one of the sensors malfunctions, wherein the virtual traffic monitoring system restricts a starting of the vehicle when a malfunctioning of at-least one of the sensors and the active devices is detected.

2. The system according to claim 1, wherein the plurality of sensors comprises a temperature sensor and a humidity sensor for determining a weather condition, at-least one Infrared (IR) sensor and a light sensor for determining a light intensity.

3. The system according to claim 1, wherein the Electronic Control Unit further comprises:
a primary microcontroller for controlling an initiation of a car start system;
a secondary microcontroller for providing an interface between the primary microcontroller and the virtual traffic monitoring system; and
a driver warning module for providing an alert to the driver regarding the malfunctioning of the pluralities of sensors and components.

4. The system according to claim 1, wherein an optical counter further comprises a pulse trigger microcontroller and a shaft encoder, wherein the pulse trigger microcontroller counts the number of pulses entering through a shaft encoder in a specific time interval, and wherein the number of counted pulse is used to determine an instantaneous speed of the vehicle.

5. The system according to claim 1, wherein the Global Position System (GPS) is connected to a plurality of active devices.

6. The system according to claim 1, wherein the Global Position System (GPS) in conjunction with at-least one of an accelerometer, the pluralities of sensors, the Radio Frequency (RF) transceiver and the optical counter, individually calculates an instantaneous speed of a vehicle, and wherein an average of the calculated instantaneous speed of the vehicle is compared with a preset speed limit.

7. The system according to claim 1, wherein a Radio Frequency (RF) Transceiver sends an alert to a nearby traffic controlling authority in case of a speed limit violation.

8. The system according to claim 1, wherein the Infrared (IR) sensor in conjunction with a Digital Imaging Device detects an illegal overtaking of the vehicle and sends an alert to the nearby traffic controlling authority for a respective traffic violation.

9. The system according to claim 1, wherein the Infrared (IR) sensor in conjunction with the ultrasonic transceiver-decoder and the Radio Frequency (RF) transceiver manipulates a distance between two moving vehicles and sends an alert to a concerned driver when the distance between two moving vehicles is less than a predetermined safe limit, and wherein a predetermined safe limit corresponds to a specified safe distance between two moving vehicle to avoid a collision.

10. The system according to claim 1, wherein the Global Position System (GPS) in conjunction with the compass and the Radio Frequency (RF) transceiver detects a symbol in a sign board in a path of a journey of a moving vehicle and sends an alert to a concerned driver corresponding to the detected symbol.

11. The system according to claim 1, wherein a symbol in the sign board comprises a U-turn, a No-Parking zone, a Left or Right Turn prohibition.

12. The system according to claim 1, wherein the Radio Frequency (RF) transceiver in conjunction with the decoder detects an illegal movement of the vehicle during a stop signal and sends an alert to the nearby traffic controlling authority.

13. The system according to claim 1, wherein the compass in conjunction with the Global Positioning System (GPS) detects an illegal reverse movement of the vehicle and sends an alert to the concerned driver.

14. The system according to claim 1, wherein a predetermined set of commands is provided to activate the Global System for Mobile Communication (GSM) module, and wherein the predetermined set of commands further comprise activating the commands for sending an SMS, sorting a contact number of a traffic controlling authority and generating a text corresponding to a traffic rule violation.

15. The system according to claim 1, wherein the outputs of the pluralities of sensors are provided to the Analog and Digital Converter (ADC) through the Global Positioning System (GPS), and wherein the Analog to Digital Converter receives analog inputs from the pluralities of sensors and converts the received analog inputs into a digital data for a long distance communication.

16. The system according to claim 1, wherein the alert sent to the traffic controlling authorities is an audio alert as well as a text alert.

17. The system according to claim 1 is further connected to the secondary microcontroller of the Electronic Control Unit which is further connected to the primary microcontroller, wherein the primary microcontroller comprises a predefined number of fuse bits, and wherein the primary micro controller is connected to a car start system of the vehicle.

18. The system according to claim 1, wherein the driver warning module of the Electronic Control Unit sends an audio alert to the driver of the concerned vehicle in case of violation of a traffic rule, and wherein the driver warning module of the Electronic Control Unit provides an audio alert during a malfunctioning of an active device.

19. A virtual traffic monitoring method to avoid traffic violation, the method comprising the steps of:
installing a virtual traffic monitoring system in a vehicle;
locking a predefined number of fuse bits of a primary microcontroller of a Electronic Control Unit;
inspecting a functioning of the installed virtual traffic monitoring system;
initiating a vehicle start system based on an inspection of a functioning of the installed virtual traffic monitoring system;
tracking a plurality of vehicular motion-affecting factors while driving the vehicle, wherein the pluralities of vehicular motion-affecting factors comprises a geographical co-ordinates, a weather condition, a light intensity and a terrain structure of a path over the vehicle is moving;
detecting a plurality of traffic rule violation during a movement of the vehicle based on the pluralities of tracked vehicular motion-affecting factors, wherein the plurality of traffic rule violation comprises exceeding a predetermined speed limit of the vehicle, an illegal overtaking of a vehicle, a sudden excessive deviation of a moving vehicle with respect to the present line of movement of the moving vehicle, driving the vehicle at a distance lesser than a predetermined safe distance between the two moving vehicles, and wherein a predetermined safe distance corresponds to a specified safe distance between two moving vehicle to avoid a collision, parking the vehicle in a no-parking zone, unfastening a seatbelt by the driver while driving the vehicle, illegal movement of the vehicle in a reverse direction and illegal movement of the vehicle in a left turn or right turn prohibited zone;
determining a continuation of the detected traffic rule violation over a predetermined sampling period; and
sending an alert to a nearby traffic control authorities for a continued traffic rule violation.
